(19) United States
(12) Patent Application Publication
(10) Pub. No.: US 2010/0171694 A1
(43) Pub. Date: Jul. 8, 2010

(54) Electronic Apparatus with Virtual Data Input Device

(76) Inventors: Chih-Hung LU, Hsinchu (TW); Cheng-Nan Tsai, Hsinchu (TW); Cheng-Kuang Sun, Hsinchu (TW); Yao-Ching Hsu, Hsinchu (TW); Yi-Hsien Ko, Hsinchu (TW); Cho-Yi Lin, Hsinchu (TW)

Correspondence Address: Portal IPR Services, P.O. box 223205, Chantilly, VA, 20153, US

(21) Appl. No.: 12/396,522

(22) Filed: Mar. 3, 2009

(30) Foreign Application Priority Data
Jan. 6, 2009 (TW) 098100193

(51) Int. Cl. G06F 3/033; G06F 3/02

(52) U.S. Cl. 345/157; 345/168

(57) ABSTRACT

An electronic apparatus with a virtual data input device includes a first body, a second body, a sensing plane, an image sensing module and a processor. A display is disposed on the second body. The sensing plane is disposed on the first body and configured for generating an initiating signal when a user presses the sensing plane. The image sensing module is disposed on the second body and configured for sensing the pressing action on the sensing plane by the user and generating an image signal that carries the information of the pressed position on the sensing plane. The processor is electrically connected with the sensing plane and the image sensing module, and configured for processing the image signal after the initiating signal is generated so that data corresponding to the pressing action of the user is input to the electronic apparatus.

### CROSS-REFERENCE TO RELATED APPLICATIONS

This application is based upon and claims the benefit of priority from the prior Taiwanese Patent Application No. 098100193, filed Jan. 6, 2009, the entire contents of which are incorporated herein by reference.

### BACKGROUND

1. Field of the Invention

This present invention relates to the field of electronics and more specifically to an electronic apparatus with a virtual data input device.

2. Description of Related Art

In many hand-held electronic apparatuses such as notebook computers and PDAs (personal digital assistants), keyboard is a common input device. A keyboard usually includes multiple keys and a mechanical-electrical interface. When a user presses a button, the pressing action is converted to a corresponding electrical signal by the mechanical-electrical interface, which can be used to input data into the electronic apparatus. Another type of regular data input devices are pointing devices, such as mice, trackballs and so on. With a pointing device, a user controls the position of a cursor or a pointer on a display screen of the electronic apparatus so as to choose the corresponding function.

However, with an increasing demand for lower cost and miniaturization of the hand-held electronic apparatuses, conventional keyboards, pointing devices and other data input device become hardly sufficient. It is therefore a problem to be solved how to further reduce the cost and the volume of hand-held electronic apparatuses.

### BRIEF SUMMARY

An object of the present invention is to provide an electronic apparatus with a virtual data input device that has advantages of saving cost and space.

A preferred embodiment of the present invention provides an electronic apparatus with a virtual data input device including a first body, a second body, a sensing plane, an image sensing module and a processor. A display is disposed on the second body. The sensing plane is disposed on the first body and configured for generating an initiating signal when a user presses the sensing plane. The image sensing module is disposed on the second body and configured for sensing the pressing action on the sensing plane by the user and generating an image signal that carries the information of the pressed position on the sensing plane. The processor is electrically connected with the sensing plane and the image sensing module, and configured for processing the image signal after the initiating signal is generated so that data corresponding to the pressing action of the user is input to the electronic apparatus.

In another preferred embodiment of the present invention, the above-mentioned sensing plane has a specific pattern printed thereon, such as a keyboard pattern. In addition, the second body is pivotally disposed on the first body.

In yet another embodiment of the present invention, an electronic apparatus with a virtual data input device is provided. The electronic apparatus includes a first body, a second body, a printed pattern, a first image sensing module, a second image sensing module, and a processor. The second body has a display disposed thereon and is pivotally disposed on the first body. The printed pattern is formed on the first body and includes a keyboard pattern and a pointing device pattern (such as a mouse pattern). The first image sensing module and the second image sensing module are disposed on the second body and apart from each other by a distance, sharing an overlapped field of view, and respectively configured for sensing an action of a user on the printed pattern and generating an image signal in response to the action. The processor is electrically connected with the first sensing module and the second sensing module, and configured for processing the image signals and thereby generating an input signal corresponding to the action. The input signal is a signal chosen from a pointer position signal for controlling a pointer's position on the display and a data input signal for realizing a keyboard function.

In still another embodiment of the present invention, an electronic apparatus with a virtual data input device is provided. The electronic apparatus includes a first body, a second body, a first image sensing module, a second image sensing module and a processor. The second body has a display disposed thereon. The first image sensing module and the second image sensing module are disposed on a side of the first body and apart from each other by a distance, sharing an overlapped field of view in which a two-dimensional virtual pointer positioning region (such as a virtual mouse region) is defined, and respectively configured for sensing an action of a user in the virtual pointer positioning region and generating an image signal in response to the action. The processor is electrically connected with the first sensing module and the second sensing module, and configured for processing the image signal and thereby generating a pointer position signal for controlling a pointer's position on the display.

In still another embodiment of the present invention, the above-mentioned first image sensing module and the second image sensing module are disposed on a sub-module that is removably connected to the first body. The sub-module is electrically connected with the first body through a connection port such as a USB port or a Firewire port.

In still another embodiment of the present invention, a keyboard comprising a mechanical-electrical interface is disposed on the above-mentioned first body.

In still another embodiment of the present invention, a sensing plane is disposed on the above-mentioned first body. The sensing plane is configured for generating an initiating signal when a user presses the sensing plane. A third image sensing module is disposed on the above-mentioned second body. The third image sensing module is configured for sensing the pressing action on the sensing plane by the user and generating an image signal that carries the information of the pressed position on the sensing plane. The processor is electrically connected with the sensing plane and the third image sensing module and configured for processing the image signal generated by the third image sensing module after the initiating signal is generated so that data corresponding to the pressing action of the user is input to the electronic apparatus. Furthermore, a keyboard pattern is printed on the sensing plane for the user's convenience in data input operations.

In the embodiments of the present invention, by replacing a conventional data input device with a virtual keyboard and/or a virtual pointing device such as a virtual mouse in the electronic apparatus, the structure of the electronic apparatus can be simplified and the dimensions of the electronic apparatus can be reduced so that the cost of the electronic apparatus and the space taken by the electronic apparatus can be saved, and thereby the growing demand for lost cost, thin and weight electronic apparatuses can be met.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a partial perspective view of an electronic apparatus with a virtual data input device in accordance with a first embodiment of the present invention.

FIG. 2 is a partial perspective view of an electronic apparatus with a virtual data input device in accordance with a second embodiment of the present invention.

FIG. 3 is a partial perspective view of an electronic apparatus with a virtual data input device in accordance with a third embodiment of the present invention.

FIG. 4 is a partial perspective view of an electronic apparatus with a virtual data input device in accordance with another embodiment of the present invention.

FIG. 5 is a partial perspective view of an electronic apparatus with a virtual data input device in accordance with yet another embodiment of the present invention.

FIG. 6 is a partial perspective view of an electronic apparatus with a virtual data input device in accordance with still another embodiment of the present invention.

FIG. 6A is a partial perspective view of an electronic apparatus with a virtual data input device in accordance with still another embodiment of the present invention.

FIG. 7 is a perspective view of a stylus of an electronic apparatus with a virtual data input device in accordance with still another embodiment of the present invention.

### DETAILED DESCRIPTION

In the following descriptions of the embodiments of the present invention, expressions of directions such as “left”, “right”, and “front” only refer to the directions in the figures and hence are not intended for limiting the scope of the present invention.

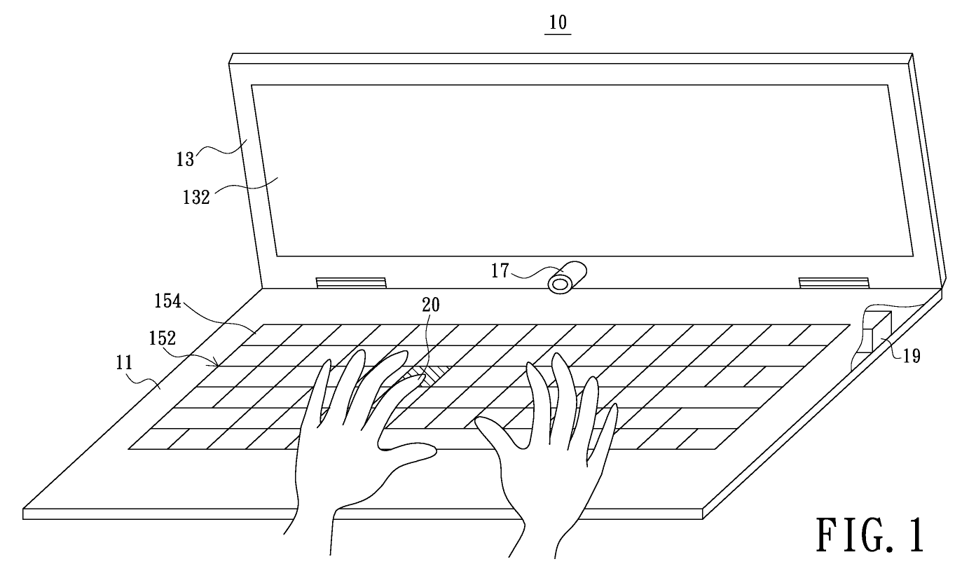

Referring to FIG. 1, a first embodiment of the present invention provides an electronic apparatus 10 with a virtual data input device. In this embodiment the electronic apparatus 10 is a notebook computer. The electronic apparatus 10 includes a first body 11, a second body 13, a sensing plane 152, an image sensing module 17 and a processor 19. The second body 13 is pivotally disposed on the first body 11. A display screen 132 is disposed on the second body 13.

The sensing plane 152 is disposed on the first body 11 and configured for generating an initiating signal when a user presses the sensing plane 152. The sensing plane 152 can be a thin film or a piece of glass capable of sensing pressure. Preferably, the sensing plane 152 can further have a specific pattern printed thereon such as a keyboard pattern 154. The keyboard pattern 154 has a plurality of press region (referred to as “virtual key” thereafter). The configuration of the keyboard pattern 154 makes it convenient for a user to press on the sensing plane 152 with a finger 20 and thereby input data to the electronic apparatus 10. On the other hand, without printing the keyboard pattern 154 on the sensing plane 122, data input can still be realized. In addition, the user can use instruments other than fingers, such as a stylus, to press on the sensing plane 152 to input data.

The image sensing module 17 is disposed on the second body 13 and configured for sensing the pressing action on the sensing plane 152 by the user's finger 20 and generating an image signal that carries the information of the pressed position on the sensing plane 152. The image sensing module 17 includes an optical lens and an image sensor. The optical lens receives light reflected from the user's finger 20 and focuses the light on the image sensor so that the image sensor generates an image signal that carries the information of the pressed position on the sensing plane 152.

The processor 19 is electrically connected to the sensing plane 152 and the image sensing module 17 and configured for processing the image signal after the initiating signal is generated so that data corresponding to the pressing action of the user is input to the electronic apparatus 10. The data input to the electronic apparatus 10 by the pressing action, after being processed by the circuit in the electronic apparatus 10, can be displayed on the display screen 132. More specifically, after receiving the initiating signal generated by the sensing plane 152, the processor 19 is notified that a pressing action is carried out, and thereby processes the image signal generated by the image sensing module 17 corresponding to the pressing action, retrieves the pressed position on the sensing plane 152, maps the corresponding information, and further carries out the data input operation corresponding to the pressed virtual key.

An example is given in the following to describe the process of the electronic apparatus 10 carrying out a data input operation. When the user's finger presses the shaded virtual key in FIG. 1, the sensing plane 152 senses the press from the user's finger 20 and generates an initiating signal, which represents that a virtual key is pressed. The image sensing module 17 senses the action of the user's finger 20 of pressing the virtual key and generates an image signal that carries the information of the pressed position. The processor 19, after receiving the initiating signal, is operated to process the image signal so as to retrieve the coordinates of the pressed position, i.e., the pressed virtual key, to map the coordinates to the data (for example, a letter or a number) corresponding to the pressed position, and thereby to complete the corresponding data input. It is to be understood that the electronic apparatus 10 can be used not only in the case of a single press of a virtual key, but also in the case of a simultaneous press of multiple keys.

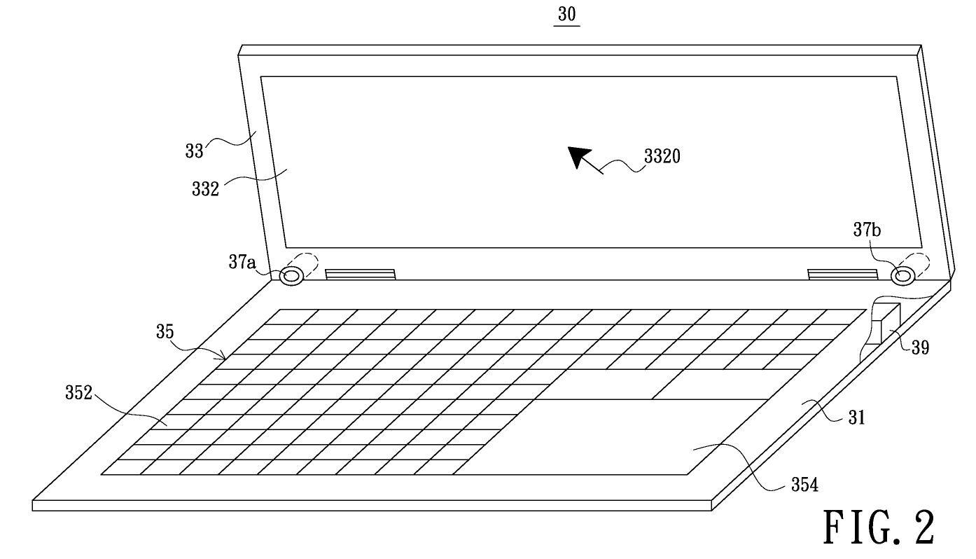

Referring to FIG. 2, a second embodiment of the present invention provides an electronic apparatus 30 with a virtual data input device. In this embodiment the electronic apparatus 30 is a notebook computer. The electronic apparatus 30 includes a first body 21, a second body 33, a printed pattern 35, a first and a second image sensing modules 37a and 37b and a processor 39. The second body 33 is pivotally disposed on the first body 31 and a display screen 332 is disposed on the second body 33.

The printed pattern 35 is formed on the first body 31 and includes a keyboard pattern 352 and a pointing device pattern such as a mouse pattern 354. It is to be understood that the pointing device pattern the printed pattern 35 includes is not limited to the mouse pattern 354 and may be other types of pointing device patterns.

The first image sensing module 37a and the second image sensing module 37b are disposed on the second body 33 and apart from each other by a distance and respectively configured for sensing an action of a user on the printed pattern and generating an image signal in response to the action. The first and second image sensing modules 37a and 37b share an overlapped field of view and respectively include an optical lens and an image sensor. The optical lenses are configured to capture the user's action and form images on the image sensors so that the image sensors respectively generate an image signal.

The processor 39 is electrically connected with the first sensing module 37a and the second sensing module 37b, and configured for processing the image signals that the image sensing modules 37a and 37b generate and thereby generating an input signal corresponding to the user's action. The input signal is a signal chosen from a pointer position signal for controlling the position of a pointer 3320 on the display screen 332 and a data input signal for realizing a keyboard function. For example, when the user carries out an action on the keyboard pattern 352 of the printed pattern 35 such as a touching action, the processor 39 generates an input signal corresponding to the user's action. When the user carries out an action on the mouse pattern 354 of the printed pattern 35, the processor 39 generates a pointer position signal corresponding to the user's action for controlling the position of a pointer 3320 on the display screen 332. The coordinates of the position where the action is carried out in the printed pattern 35 can be determined by triangulation method or other similar positioning methods.

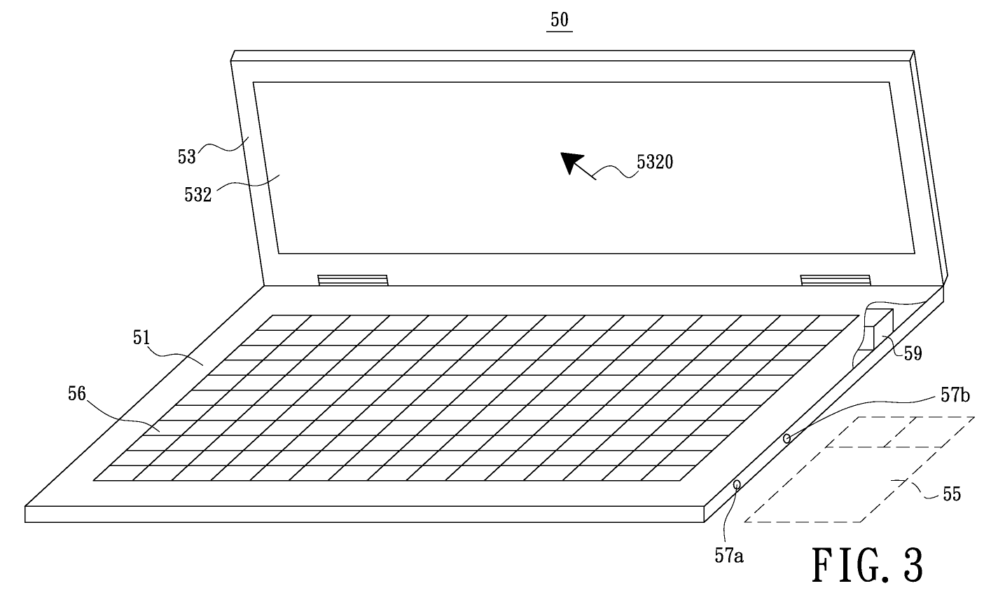

Referring to FIG. 3, a third embodiment of the present invention provides an electronic apparatus 50 with a virtual data input device. In this embodiment the electronic apparatus 50 is a notebook computer. The electronic apparatus 50 includes a first body 51, a second body 53, a keyboard 56, a first image sensing module 57a, a second image sensing module 57b, and a processor 59. The second body 53 has a display screen 532 disposed thereon and is pivotally disposed on the first body 51.

The keyboard 56 can be a conventional keyboard having a mechanical-electrical interface and a plurality of keys. A user can input data to the electronic apparatus by pushing the keys on the keyboard 56. The data is processed by the circuit in the electronic apparatus 50 and sent to the display screen 532 to be displayed.

The first image sensing module 57a and the second image sensing module 57b are disposed on a left side of the first body 51 and apart from each other by a distance, and sharing an overlapped field of view in which a two-dimensional virtual pointer positioning region is defined such as a virtual mouse region 55. The first image sensing module 57a and the second image sensing module 57b are respectively configured for sensing an action of a user in the virtual mouse region 55 and generating an image signal in response to the action. The first image sensing module 57a and the second image sensing module 57b respectively include an optical lens and an image sensor. The optical lenses are configured to capture the user's action and form images on the image sensors.

The processor 59 is electrically connected with the first sensing module 57a and the second sensing module 57b, and configured for processing the image signals that the image sensing modules 57a and 57b generate and thereby generating a pointer position signal for controlling the position of a pointer 5320 on the display screen 532. The coordinates of the position where the action is carried out in the virtual mouse region 55 can be determined by triangulation method or other similar positioning methods.

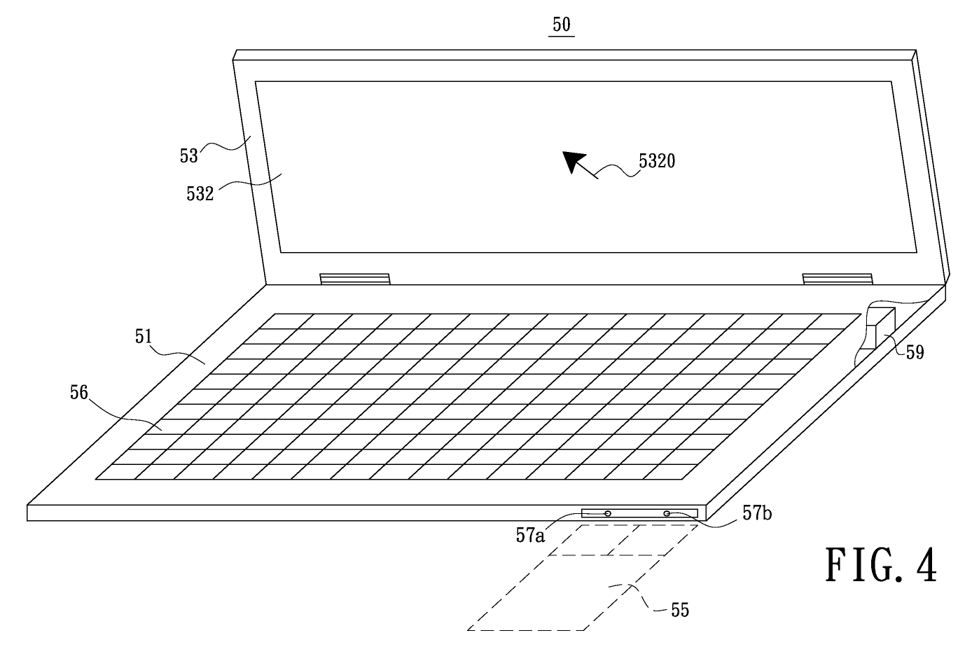

It is to be understood that the first sensing module 57a and the second sensing module 57b are not limited to be disposed on the left side of the first body 51 and can be dispose on a front side of the first body 51, as shown in FIG. 4, or disposed on other sides such as the right side.

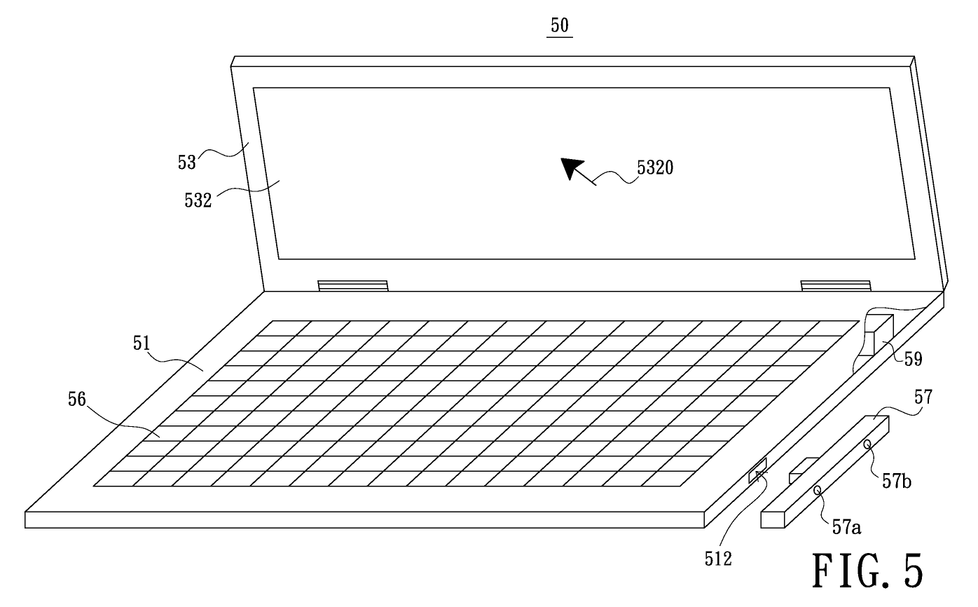

Further, the first sensing module 57a and the second sensing module 57b are not limited to be disposed directly on the first body 51 and can be disposed on a sub-module 57 that is removably connected to the first body 51, as shown in FIG. 5. The sub-module 57 is electrically connected with the first body 51 through a connection port such as a USB port or a Firewire port.

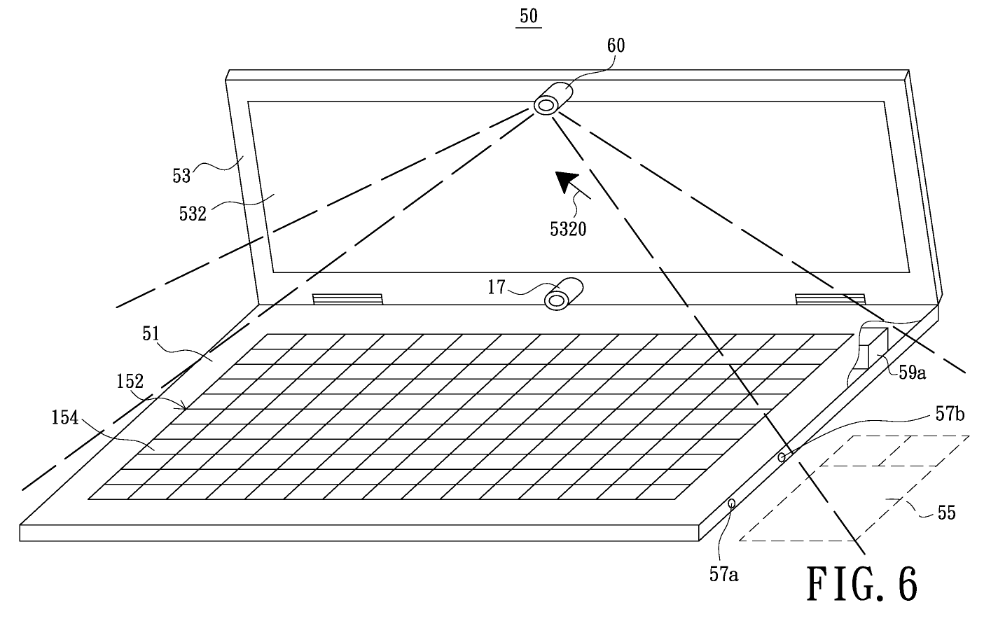

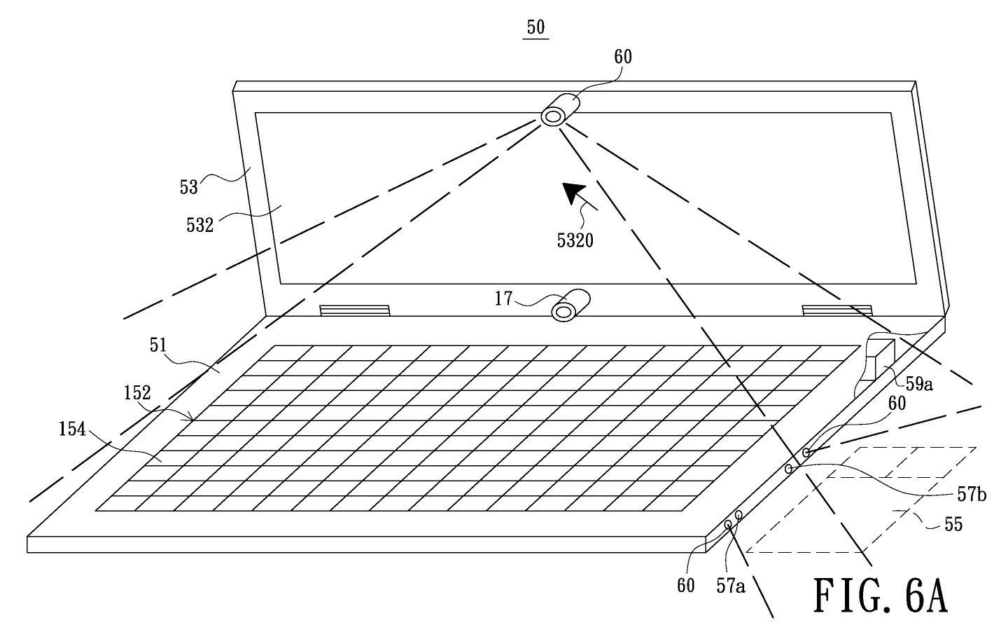

In addition, the electronic apparatus 50 provided by the third embodiment of the present invention is not limited to relying on the conventional keyboard 56 with a mechanical-electrical interface for data input. More specifically, as shown in FIG. 6, the electrical apparatus 50 includes a first body 51, a second body 53, a virtual mouse pattern 55, a first image sensing module 57a, a second image sensing module 57b, a processor 59a, a sensing plane 152, a keyboard pattern 154 and a third image sensing module 17. The sensing plane 152 is electrically connected with the processor 59a and configured for generating an initiating signal when a user presses the sensing plane 152. The processor 59a is electrically connected with the third image sensing module 17 and configured for receiving and processing the image signal generated by the third image sensing module 17 after the initiating signal is generated so that data corresponding to the pressing action of the user is input to the electronic apparatus 50 and the keyboard function is thus realized. The first and second image sensing modules 57a and 57b are electrically connected to the processor 59a and respectively configured for sensing an action of the user in the virtual mouse region 55 and generating an image signal in response to the action. The processor 59a is configured to process the image signal then and generate a pointer position signal for controlling the position of a pointer 5320 on the display screen 532. To be put in a simple way, the processor 59a is configured to essentially carry both the function of the processor 19 in the first embodiment and the function of the processor 59 in the third embodiment.

Furthermore, as shown in FIG. 6, an infrared light source 60 for emitting infrared light can be disposed on the second body 53 of the electronic apparatus 50. The sensing pane 152 and the virtual mouse region are disposed within the luminance range of the infrared light source 60. The keyboard pattern 154 is disposed in the luminance range of the infrared light source 60. Correspondingly, the image sensing modules 17, 57a and 57b further respectively include an infrared pass filter (not shown in FIG. 6), in addition to the optical lens and the image sensor. The infrared pass filter can be placed in the optical lens or other appropriate locations, as long as it is on the image sensing side of the image sensor. By this means, signal noise of the image sensing modules 17, 57a and 57b can be reduced and sensing accuracy thereof can be improved.

It is to be noted that, as shown in FIG. 6A, the number of the infrared light source 60 is not limited to one. In the case where multiple infrared light sources 60 are used, two infrared light sources 60 can be respectively disposed beside the first image sensing module 57a and the second image sensing module 57b, and the virtual mouse region 55 is positioned within the luminance range of these infrared light sources 60.

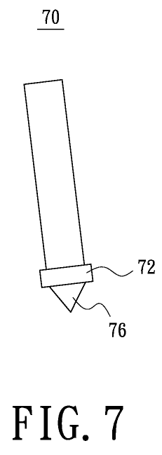

In order to reduce the signal noise of the image sensing modules 17, 57a and 57b and improve the sensing accuracy thereof, the infrared light source 60 may be eliminated from the first body 51 or the second body 53, and instead, as shown in FIG. 7, if the user is to use a stylus to input data, an infrared light source 72 and a detection unit (not shown in FIG. 7) may be disposed on a stylus 70. The detection unit can be a pressure sensor. When a tip 76 of the stylus 70 touches the sensing plane 152 or the virtual mouse region 55, the infrared light source 72 is turned on to emit infrared light. It is to be understood, in the case when the stylus 70 is used, the infrared light sources 60 can still be disposed on the first body 51 and/or the second body 53, and the infrared light source 72 can be used as an assisting light source. Preferably, the luminosity of the assisting infrared light source 72 is greater than the luminosity of the infrared light sources 60. In addition, the configuration of the infrared light sources 60 and 72 and the infrared pass filters can be used in the electronic apparatus 10 provided by the first embodiment and the electronic apparatus 30 provided by the second embodiment as well.

The electronic apparatuses in the above embodiments are notebook computers, however, an ordinary person in the art would understand the electronic apparatus according to the present invention is not limited to notebook computers and can be other types of hand-held electronic devices such as PDAs (personal digital assistants) and hand-held game machines, or other electronic apparatuses such as desktop computers.

In summary, in the embodiments of the present invention, by replacing a conventional data input device with a virtual keyboard and/or a virtual pointing device such as a virtual mouse in the electronic apparatus, the structure of the electronic apparatus can be simplified and the dimensions of the electronic apparatus can be reduced so that the cost of the electronic apparatus and the space taken by the electronic apparatus can be saved, and thereby the growing demand for lost cost, thin and weight electronic apparatuses can be met.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electronic apparatus with a virtual data input device, comprising:
a first body;
a second body with a display disposed thereon;
a sensing plane disposed on the first body and configured for generating an initiating signal when a user presses the sensing plane;
an image sensing module disposed on the second body and configured for sensing the pressing action on the sensing plane by the user and generating an image signal that carries the information of the pressed position on the sensing plane; and
a processor electrically connected with the sensing plane and the image sensing module, and configured for processing the image signal after the initiating signal is generated so that data corresponding to the pressing action of the user is input to the electronic apparatus.

2. The electronic apparatus of claim 1, wherein the sensing plane has a specific pattern printed thereon.

3. The electronic apparatus of claim 2, wherein the specific pattern is a keyboard pattern, the keyboard pattern comprising a plurality of virtual buttons.

4. The electronic apparatus of claim 1, wherein the second body is pivotally disposed on the first body.

5. The electronic apparatus of claim 1, further comprising an infrared light source, the sensing plane being disposed within the luminance range of the infrared light source, the image sensing module comprising an infrared pass filter.

6. The electronic apparatus of claim 1, further comprises a stylus, an infrared light source being disposed on the stylus, the infrared light source being configured to be turned on when a tip of the stylus touches the sensing plane, the image sensing module comprising an infrared pass filter.

7. The electronic apparatus of claim 5, further comprising a stylus, an assisting infrared light source being disposed on the stylus, the assisting infrared light source being configured to be turned on when a tip of the stylus touches the sensing plane, the luminosity of the assisting infrared light source is greater than the luminosity of the infrared light source.

8. An electronic apparatus with a virtual data input device, comprising:
a first body;
a second body with a display disposed thereon, the second body being pivotally disposed on the first body;
a printed pattern formed on the first body, the printed pattern comprising a keyboard pattern and a pointing device pattern;
a first image sensing module and a second image sensing module, disposed on the second body and apart from each other by a distance, sharing an overlapped field of view, and respectively configured for sensing an action of a user on the printed pattern and generating an image signal in response to the action; and
a processor electrically connected with the first sensing module and the second sensing module, and configured for processing the image signals and thereby generating an input signal corresponding to the action, the input signal being a signal chosen from a pointer position signal for controlling a pointer's position on the display and a data input signal for realizing a keyboard function.

9. The electronic apparatus of claim 8, wherein the pointing device pattern is a mouse pattern.

10. The electronic apparatus of claim 8, further comprising an infrared light source, the printed pattern being disposed within the luminance range of the infrared light source, the image sensing module comprising an infrared pass filter.

11. The electronic apparatus of claim 8, further comprising a stylus, an infrared light source being disposed on the stylus, the infrared light source being configured to be turned on when a tip of the stylus touches the printed pattern, the image sensing module comprising an infrared pass filter.

12. The electronic apparatus of claim 10, further comprising a stylus, an assisting infrared light source being disposed on the stylus, the assisting infrared light source being configured to be turned on when a tip of the stylus touches the printed pattern, the luminosity of the assisting infrared light source is greater than the luminosity of the infrared light source.

13. An electronic apparatus with a virtual data input device, comprising:
a first body;
a second body with a display disposed thereon;
a first image sensing module and a second image sensing module, disposed on a side of the first body and apart from each other by a distance, sharing an overlapped field of view in which a two-dimensional virtual pointer positioning region is defined, and respectively configured for sensing an action of a user in the virtual pointer positioning region and generating an image signal in response to the action; and
a processor electrically connected with the first sensing module and the second sensing module, and configured for processing the image signal and thereby generating a pointer position signal for controlling a pointer's position on the display.

14. The electronic apparatus of claim 13, wherein the first image sensing module and the second image sensing module are disposed on a sub-module that is removably connected to the first body, the sub-module being electrically connected with the first body through a connection port.

15. The electronic apparatus of claim 13, wherein a keyboard comprising a mechanical-electrical interface is disposed on the first body.

16. The electronic apparatus of claim 13, further comprising an infrared light source, the virtual pointer positioning region being disposed within the luminance range of the infrared light source, the image sensing modules respectively comprising an infrared pass filter.

17. The electronic apparatus of claim 13, further comprising a stylus, an infrared light source being disposed on the stylus, the infrared light source being configured to be turned on when a tip of the stylus touches the virtual pointer positioning region, the image sensing module comprising an infrared pass filter.

18. The electronic apparatus of claim 16, further comprising a stylus, an assisting infrared light source being disposed on the stylus, the assisting infrared light source being configured to be turned on when a tip of the stylus touches the virtual pointer positioning region, the luminosity of the assisting infrared light source is greater than the luminosity of the infrared light source.

19. The electronic apparatus of claim 13, wherein a sensing plane is disposed on the first body, the sensing plane being configured for generating an initiating signal when a user presses the sensing plane; a third image sensing module is disposed on the second body, the third image sensing module being configured for sensing the pressing action on the sensing plane by the user and generating an image signal that carries the information of the pressed position on the sensing plane; the processor is electrically connected with the sensing plane and the third image sensing module and configured for processing the image signal generated by the third image sensing module after the initiating signal is generated so that data corresponding to the pressing action of the user is input to the electronic apparatus.

20. The electronic apparatus of claim 19, wherein a keyboard pattern is printed on the sensing plane.
